(19) United States
(12) Patent Application Publication
(10) Pub. No.: US 2026/0036452 A1
(43) Pub. Date: Feb. 5, 2026

(54) Calibration Method For Sensor Module, Sensor Module And Smart Cleaning Device

(71) Applicants: TE Connectivity Solutions GmbH, Schaffhausen (CH); Tyco Electronics (Shanghai) Co., Ltd., Shanghai (CN)

(72) Inventors: Weifeng Bian, Shanghai (CN); Minghui Shao, Shanghai (CN); Yongyao Cai, Middletown, PA (US)

(73) Assignees: TE Connectivity Solutions GmbH, Schaffhausen (CH); Tyco Electronics (Shanghai) Co., Ltd., Shanghai (CN)

(21) Appl. No.: 19/286,425

(22) Filed: Jul. 31, 2025

(30) Foreign Application Priority Data
Jul. 31, 2024 (CN) 202411045720.X

(51) Int. Cl. G01D 18/00; D06F 103/20

(52) U.S. Cl. CPC G01D 18/00; A47L 2401/10; D06F 2103/20

(57) ABSTRACT

A calibration method for a sensor module of a smart cleaning device includes providing a sensor module. The sensor module has a plurality of sensors, a control unit, a switch circuit, a calibration circuit and a measurement circuit. The plurality of sensors comprise at least one turbidity sensor. The method also includes controlling, by the control unit, the switch circuit to be turned on to supply power to the turbidity sensor, in response to a calibration command to the turbidity sensor from a main controller of the smart cleaning device. The method further includes adjusting, by the control unit, an input of the turbidity sensor via the calibration circuit, obtaining an output of the turbidity sensor via the measurement circuit, and adjusting the input based on the output until the output meets a preset range. The method additionally includes sending, by the control unit, a calibration completion information to the main controller.

### CROSS-REFERENCE TO RELATED APPLICATION

This application claims the benefit of the filing date under 35 U.S.C. § 119(a)-(d) of Chinese Patent Application No. 202411045720.X, filed on Jul. 31, 2024.

### FIELD OF THE INVENTION

The present invention relates to the field of cleaning devices and, more particularly, to a calibration method for a sensor module of a smart cleaning device, a sensor module, and a smart cleaning device.

### BACKGROUND OF THE INVENTION

With the progress of science and technology and the improvement of people's living standards, smart cleaning devices such as washing machines and dishwashers have become an important part of household products. Such devices are usually equipped with turbidity sensors for detecting the turbidity of water in the cleaning process, so as to determine the degree of cleanliness of the washed items, and determine the optimal washing time and rinsing time accordingly. However, due to the influence of various factors such as water quality, temperature and light source intensity, the measurement accuracy of the turbidity sensor may be affected, resulting in poor cleaning effect or resource waste.

FIGS. 1-3 show schematic diagrams of some existing turbidity sensors. FIG. 1 is a schematic diagram of a turbidity sensor without an in-use calibration (on-site calibration) function. Such turbidity sensors are calibrated at factory production (factory calibration) and are no longer calibrated in use. When the turbidity sensor is factory calibrated, the variable resistance (VR) is adjusted for calibration. R1 may be used for voltage division and current limiting. The voltage and current of the phototransistor (PTr) may be calculated by measuring the current and voltage of R1, so that the turbidity of the measurement object may be obtained. When the light of the LED irradiates the sensitive area of PTr, the internal electronic state thereof may be changed, thereby the resistance or current thereof may be changed, which is one of the key components of the sensor circuit. A smaller voltage of PTr indicates a smaller current flowing through PTr and a larger turbidity of the liquid. After the turbidity sensor is used for a long time, the light path of the turbidity sensor is affected due to dust accumulation of the housing, resulting in a large measurement deviation.

FIG. 2 is a schematic diagram of a turbidity sensor having an on-site calibration function. FIG. 3 is a schematic diagram of connection between the main controller of the device and the turbidity sensor having an on-site calibration function. The control unit 310 in the main controller 300 supplies power to the turbidity sensor 200 via the switch circuit 320, calibrates the turbidity sensor 200 via the calibration circuit 330, and obtains turbidity data of the turbidity sensor 200 via the measurement circuit 340. Although the turbidity sensor shown in FIGS. 2-3 can improve its detection accuracy through on-site calibration, however, since the calibration process is controlled to execute by the main controller 300, and the control unit 310, the switch circuit 320, the calibration circuit 330 and the measurement circuit 340 are all provided on the main controller 300, and the coupling degree between the main controller 300 and the turbidity sensor 200 is too large, therefore, it is inconvenient for product upgrade and the turbidity sensor 200 is not as universally usable.

### SUMMARY OF THE INVENTION

A calibration method for a sensor module of a smart cleaning device includes providing a sensor module. The sensor module has a plurality of sensors, a control unit, a switch circuit, a calibration circuit and a measurement circuit. The plurality of sensors comprise at least one turbidity sensor. The method also includes controlling, by the control unit, the switch circuit to be turned on to supply power to the turbidity sensor, in response to a calibration command to the turbidity sensor from a main controller of the smart cleaning device. The method further includes adjusting, by the control unit, an input of the turbidity sensor via the calibration circuit, obtaining an output of the turbidity sensor via the measurement circuit, and adjusting the input based on the output until the output meets a preset range. The method additionally includes sending, by the control unit, a calibration completion information to the main controller.

### BRIEF DESCRIPTION OF DRAWINGS

The invention will now be described by way of example with reference to the accompanying figures, of which:

FIG. 1 is a schematic diagram of a prior art turbidity sensor;

FIG. 2 is a schematic diagram of another on-site calibratable prior art turbidity sensor;

FIG. 3 is a schematic diagram of the prior art turbidity sensor of FIG. 2 connected to a main controller;

FIG. 4 is a block diagram of a sensor module according to an embodiment of the present disclosure;

FIG. 5 is a schematic diagram of a calibration method for the sensor module of FIG. 4 of a smart cleaning device according to an embodiment of the present disclosure;

FIG. 6 shows a schematic structural diagram of the sensor module of FIG. 4 having a turbidity sensor and a main controller according to an embodiment of the present disclosure;

FIG. 7 is a schematic structural diagram of a sensor module having a main controller according to another embodiment of the present disclosure;

FIG. 8 is a graph of a relationship between the turbidity (NTU) and the voltage (U) according to an embodiment of the present disclosure; and

FIG. 9 is a graph of the relationship between the turbidity (NTU) and the communication data (CD) according to an embodiment of the present disclosure.

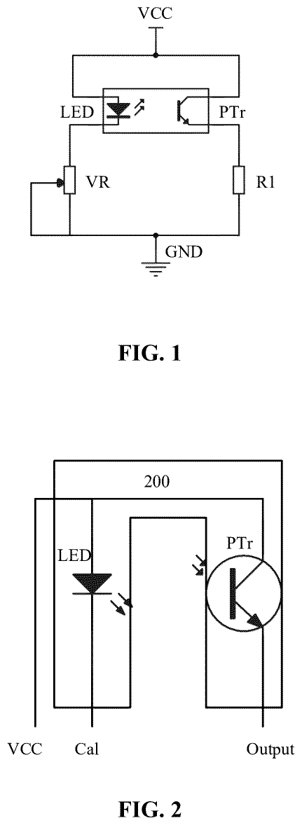

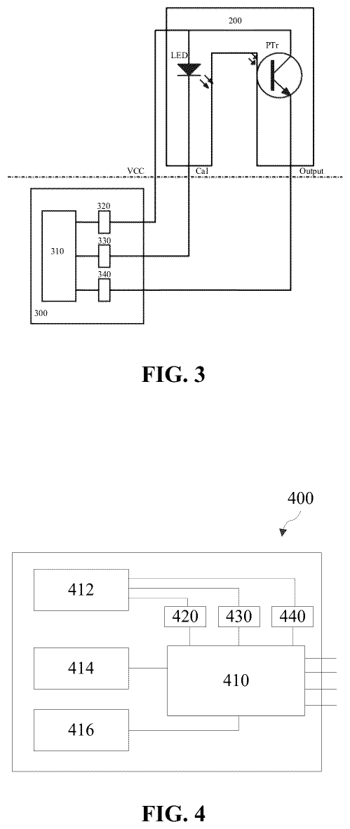

### DETAILED DESCRIPTION

The implementation and use of embodiments will be discussed in detail below. However, it should be understood that the specific embodiments discussed only are only intended to provide exemplary examples of specific ways to implement and use the present disclosure, rather than to limit the scope of the present disclosure. The descriptions used for each component, such as upper, lower, left, right, top, bottom, etc., are not absolute, but relative. When each component is arranged as shown in the diagram, these expressions are appropriate, but when the position of each component in the diagram changes, these expressions also change accordingly.

As shown in FIG. 4, an embodiment of the present disclosure provides a sensor module 400 (an all-in-one sensor module) for a smart cleaning device. The sensor module 400 includes a plurality of sensors 412, 414, 416. Although FIG. 4 illustrates three sensors as an example, the number of sensors that the sensor module 400 has is not limited. The plurality of sensors includes at least one turbidity sensor 412. The sensor module 400 further includes a control unit 410, a switch circuit 420, a calibration circuit 430, and a measurement circuit 440. The plurality of sensors are respectively connected to the control unit 410.

The control unit 410, as shown in FIG. 4, may be configured to: control the switch circuit 420 to be turned on to supply power to the turbidity sensor 412, in response to a calibration command to the turbidity sensor 412 from the main controller of the smart cleaning device; adjust the input of the turbidity sensor 412 via the calibration circuit 430, obtain the output of the turbidity sensor 412 via the measurement circuit 440, and adjust the input of the turbidity sensor 412 based on the output of the turbidity sensor 412 until the output of the turbidity sensor 412 meets the preset range; and send the calibration completion information to the main controller.

In some examples, the main controller is communicatively connected to the sensor module via a data bus. The data bus communication can not only meet the higher requirements for communication quality as the quantity and type of sensors in the smart cleaning device gradually increase, but also simplify the wiring of the smart cleaning device and reduce the complexity of the circuit wiring design of the smart cleaning device. Optionally, the data bus communication may be UART communication, CAN communication, RS485 communication or the like.

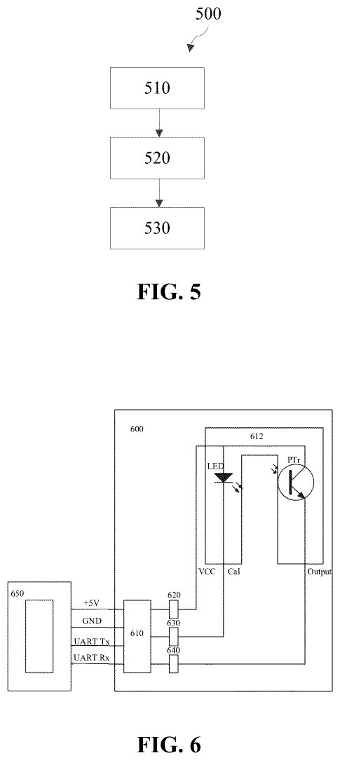

As shown in FIG. 5, an embodiment of the present disclosure provides a calibration method 500 for a sensor module a smart cleaning device. The sensor module 400 includes a plurality of sensors 412, 414, 416, a control unit 410, a switch circuit 420, a calibration circuit 430, and a measurement circuit 440. The plurality of sensors 412, 414, 416 include at least one turbidity sensor 412. The plurality of sensors 412, 414, 416 may further include any one or a combination of a pressure sensor, a temperature sensor, a conductivity sensor, and an acceleration sensor.

As shown in FIG. 5, the steps of the calibration method 500 may include a step 510, a step 520, and a step 530.

In the step 510, as shown in FIG. 5, the control unit 410 controls the switch circuit 420 to be turned on to supply power to the turbidity sensor 412 in response to the calibration command to the turbidity sensor 412 from the main controller of the smart cleaning device. In some examples, the manner of generating the calibration command to the turbidity sensor 412 from the main controller of the smart cleaning device includes: obtaining, by the control unit 410, the washing process data for each time of the turbidity sensor 412; determining whether the turbidity sensor 412 needs to be calibrated based on the washing process data; sending a calibration request to the main controller in response to a determination result that the turbidity sensor 412 needs to be calibrated; and sending, by the main controller, the calibration command in response to the calibration request.

In the step 520, as shown in FIG. 5, the control unit 410 adjusts the input of the turbidity sensor 412 via the calibration circuit 430, obtains the output of the turbidity sensor 412 via the measurement circuit 440, and adjusts the input of the turbidity sensor 412 based on the output of the turbidity sensor 412 until the output of the turbidity sensor 412 meets the preset range.

In the step 530, as shown in FIG. 5, the control unit 410 sends the calibration completion information to the main controller. In some examples, after the control unit 410 sends the calibration completion information to the main controller, when it is determined that it does not need the turbidity sensor 412 to work, the switch circuit 420 is controlled to be turned off. In some other examples, the power supply manner of the turbidity sensor 412 is continuous power supply. In the present disclosure, power supply to the turbidity sensor 412 is controlled, that is, when it needs the turbidity sensor 412 to work (when there is a need to calibrate or when the smart cleaning device performs washing work), the switch circuit 420 is turned on to supply power to the turbidity sensor 412; and when it does not need the turbidity sensor 412 to work, the switch circuit 420 is turned off to stop supplying power, which can effectively prolong the use life of the turbidity sensor 412.

The calibration method 500 reduces the coupling degree between the main controller and the turbidity sensor 412 in the smart cleaning device, facilitates product upgrade, and greatly improves universality of the turbidity sensor 412 and the main controller. For example, when a sensor in a product is updated, there is no need to replace the main controller. As another example, the same main controller may be applicable to more different manufacturers and different types of sensors.

In some examples, the manner of determining whether the turbidity sensor 412 needs to be calibrated includes: the main controller determining whether the calibration command to the turbidity sensor 412 needs to be initiated by calculating the washing times or the machine usage time. In some other examples, the manner of determining whether the turbidity sensor 412 needs to be calibrated includes: the turbidity sensor 412 analyzing whether the data has a deviation by comparing and analyzing data in each washing process, determining whether a calibration needs to be performed by using an appropriate algorithm, and sending turbidity calibration information to the main controller. Further, in another example, the manner of determining whether the turbidity sensor 412 needs to be calibrated includes: obtaining a data average value, a data average maximum value, and/or a data average minimum value of each washing process of the smart cleaning device; comparing the data average value, the data average maximum value, and/or the data average minimum value with initial data and/or calibrated data, and determining that the turbidity sensor 412 needs to be calibrated when a comparison result exceeds a preset range; and sending the calibration command by the main controller to the control unit 410 in response to the determination result.

A specific example is provided as follows: in a washing machine using a turbidity sensor, when it is detected that the turbidity of water is lower than a set value, it is considered that the washing is completed. When the main controller requests to send turbidity data, the turbidity sensor records the data average value, the data average maximum value, and the data average minimum value transmitted in one washing process in a local storage unit. The manner of calculating the data average value may be: calculating the average value within each minute, and then calculating the average value of the average value within each minute in one washing process as the data average value of one washing. The manner of calculating the average maximum value may be: calculating the average value of the first 100 maximum values in one washing process. The manner of calculating the average minimum value may be: calculating the average value of the first 100 minimum values in one washing process. During each washing process, the change trends of these values are compared, and if the deviation from the initial data or the calibrated data is higher than the preset threshold, it is determined that calibration is required. The stored data is updated after calibration.

FIG. 6 shows a schematic structural diagram of a sensor module 600 and a main controller 650, the sensor module 600 including a turbidity sensor 612. The sensors in the sensor module 600 other than the turbidity sensor 612 are not shown. Optionally, the main controller 650 may be connected to one or more sensor modules via the data bus. The sensor module 600 includes a control unit 610, a turbidity sensor 612, a switch circuit 620, a calibration circuit 630, and a measurement circuit 640. As shown in FIG. 6, the power switch circuit 620, the calibration circuit 630, and the measurement circuit 640 of the turbidity sensor 612 are disposed on the sensor module 600 with the turbidity sensor 612, which implements hardware decoupling between the main controller 650 and the sensor module 600, thereby improving universality of the turbidity sensor 612, convenience of upgrading the main controller 650, and maintainability of the system.

In some examples, the calibration process of the turbidity sensor 612 in the sensor module 600 shown in FIG. 6 may be expressed as follows: the calibration liquid (for example, clean water) is injected into the smart cleaning device (for example, a washing machine or a dishwasher); the main controller 650 sends a turbidity sensor calibration command to the sensor module 600 with the turbidity sensor 612; the control unit 610 in the sensor module 600 returns calibration information to the main controller 650, and enters a calibration process; the main controller 650 waits for calibration completion information of the turbidity sensor 612, and the control unit 610 turns on the switch circuit 620; the input of the calibration circuit 630 (usually PWM value or Analog Voltage value) is adjusted; the output of the turbidity sensor 612 is measured by the measurement circuit 640; the measured voltage value is compared with the calibration standard value, and if the voltage value is equal to the calibration standard value, enter next step, and if the voltage value is not equal to the calibration standard value, the input of the calibration circuit 630 is adjusted again by an algorithm; the input value of the calibration circuit 630 is recorded in the EEPROM of the control unit 610 of the sensor module 600, and may be used for later measurement; and the switch circuit 620 is turned off, the calibration process of the turbidity sensor 612 is exited, and the calibration completion information is sent to the main controller 650.

FIG. 7 is a schematic structural diagram of a sensor module 700 and a main controller 750 according to an embodiment of the present disclosure. The sensor module 700 (all-in-one) includes a plurality of sensors 712, 714, 716, and 718. The plurality of sensors 712, 714, 716 and 718 are respectively connected to the control unit 710. The control unit 710 is communicatively connected to the main controller 750 via the data bus. The plurality of sensors may include any one or a combination of a MEMS pressure sensor, a temperature sensor, a turbidity sensor 712, and a conductivity sensor, and may also include other types of sensors. These sensors are connected to the control unit 710 of the sensor module 700 via suitable hardware circuitry. The control unit 710 may be a microcontroller unit (MCU). The MCU collects data of each sensor, performs algorithm calculation, packages the data, and then transmits the data of each sensor to the main controller 750 via the Universal Asynchronous Receiver/Transmitter (UART) communication port. The main controller 750 uses the data to control each component of the washing machine or dishwasher to complete the washing process. The main controller 750 and the sensor module 700 may be connected in a one-to-one manner (that is, one main controller 750 corresponds to one sensor module 700), or may be connected in a one-to-many manner (that is, one main controller 750 corresponds to a plurality of sensor modules 700).

Further, the turbidity sensor 712 of the sensor module 700, as shown in FIG. 7, may be calibrated in the following manner: the main controller 750 enters a calibration state, and sends a calibration command to the sensor module 700; the sensor module 700 enters a measurement mode to measure the turbidity value at this time, and records the turbidity value in a memory (for example, an EEPROM); a calibrated measurement value is obtained after calculating based on the measurement value and the check value in the record; and the calibrated measurement value is sent to the main controller 750, and the calibration completion information is sent to the main controller 750. In some other examples, the difference between the measurement value and the check value may be sent to the main controller 750 as a correction value to correct the subsequent measurement value.

In some examples, the sensor module 400,600,700 having the bus structure may perform processing of a non-linear relationship. And the signal received by the main controller 650,750, and the main controller sending the calibration command to the turbidity sensor 412, is the value of the linear measured physical quantity. By transferring the processing of non-linear relationship between the voltage and the turbidity that needs to be performed by the main controller 300 in the prior art to the sensor module 400,600,700, not only the processing workload of the main controller 650,750, and the main controller sending the calibration command to the turbidity sensor 412, is reduced, but also the coupling degree between the turbidity sensor 412,612,712 and the main controller 650,750, and the main controller sending the calibration command to the turbidity sensor 412, is reduced.

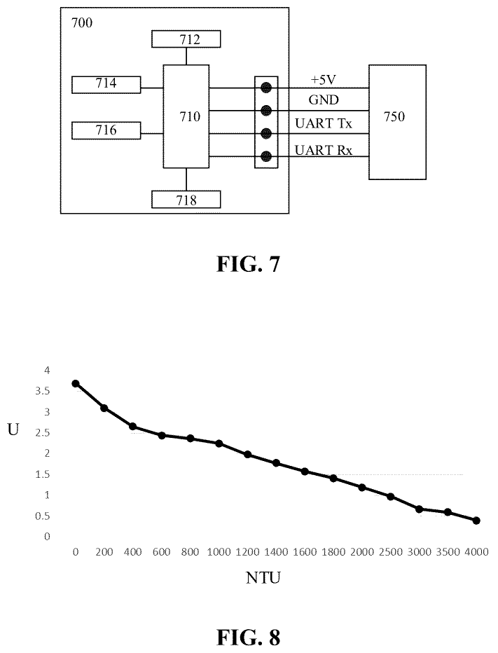

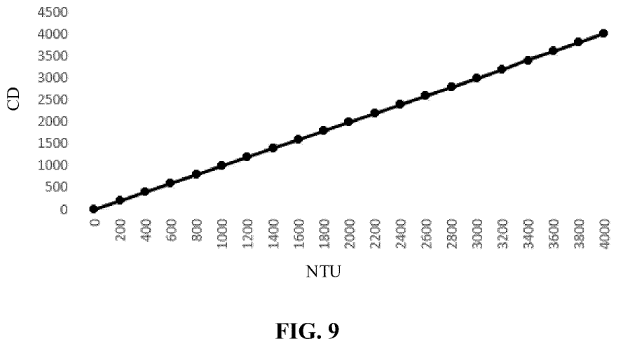

A graph of the relationship between the turbidity (NTU) and the voltage (U) before transferring is shown in FIG. 8, and a graph of the relationship between the turbidity (NTU) and the communication data CD after transferring is shown in FIG. 9. The communication data CD is the value of the linear measured physical quantity obtained after linear processing of the voltage.

In some examples, the control unit 410,610,710 adjusts the input of the turbidity sensor 412,612,712 based on the output of the turbidity sensor 412,612,712, including the control unit 410,610,710 linear processing turbidity data and voltage data of the turbidity sensor 412,612,712, and adjusting the input of the turbidity sensor 412,612,712 based on the result of the linear processing.

In some examples, the communication data packet between the main controller 650, and the main controller sending the calibration command to the turbidity sensor 412, and the sensor module 400,600 includes the data bit indicating whether the main controller 750, and the main controller sending the calibration command to the turbidity sensor 412, needs information of each sensor. When the data bit associated with the turbidity sensor 412,612 in the communication data packet is set to a first value (for example, set to 0), the control unit 410,610 determines that there is no need to measure the data of the turbidity sensor 412,612, and controls the switch circuit 420,620 to be turned off. When the data bit associated with the turbidity sensor 412,612 in the communication data packet is set to a second value (for example, set to 1), the control unit 410,610 determines that there is a need to measure the data of the turbidity sensor 412,612, and controls the switch circuit 420,620 to be turned on.

The various calibration methods for the sensor module of the smart cleaning device, as described above, can reduce the coupling degree between the smart cleaning device such as a washing machine or a dishwasher and the sensor module 400,600,700 with the turbidity sensor 412,612,712, improve the maintainability of the system, retain the in-use calibration function of the turbidity sensor 412,612,712, improve the long-term use accuracy of the turbidity sensor 412,612,712 and prolong the use life of the turbidity sensor 412,612,712.

Although the present disclosure has been described with reference to specific examples, these examples are merely illustrative and are not intended to limit the present disclosure. It is obvious to those skilled in the art that changes, additions, or deletions to the disclosed embodiments can be made without departing from the spirit and scope of protection of the present disclosure.

1. A calibration method for a sensor module of a smart cleaning device, comprising:
providing a sensor module having a plurality of sensors, a control unit, a switch circuit, a calibration circuit, and a measurement circuit, the plurality of sensors comprising at least one turbidity sensor;
controlling, by the control unit, the switch circuit to be turned on to supply power to the turbidity sensor, in response to a calibration command to the turbidity sensor from a main controller of the smart cleaning device;
adjusting, by the control unit, an input of the turbidity sensor via the calibration circuit, obtaining an output of the turbidity sensor via the measurement circuit, and adjusting the input based on the output until the output meets a preset range; and
sending, by the control unit, a calibration completion information to the main controller.

2. The method of claim 1, wherein a manner of generating the calibration command to the turbidity sensor from the main controller of the smart cleaning device includes obtaining, by the control unit, a washing process data for each time of the turbidity sensor, determining whether the turbidity sensor needs to be calibrated based on the washing process data, sending a calibration request to the main controller in response to a determination result that the turbidity sensor needs to be calibrated, and sending, by the main controller, the calibration command in response to the calibration request.

3. The method of claim 2, wherein determining whether the turbidity sensor needs to be calibrated includes obtaining a data average value, a data average maximum value, and/or a data average minimum value of each washing process of the smart cleaning device, comparing the data average value, the data average maximum value and/or the data average minimum value with initial data and/or calibrated data, and determining that the turbidity sensor needs to be calibrated when a comparison result exceeds the preset range, and sending, by the main controller, the calibration command to the control unit in response to the determination result.

4. The method of claim 1, wherein the main controller is communicatively connected to the sensor module via a data bus.

5. The calibration method of claim 1, wherein adjusting, by the control unit, the input of the turbidity sensor based on the output of the turbidity sensor, includes linear processing, by the control unit, a turbidity data and a voltage data of the turbidity sensor, and adjusting the input of the turbidity sensor based on a result of the linear processing.

6. The method of claim 1, wherein a communication data packet between the main controller and the sensor module comprises a data bit indicating whether the main controller needs information of each sensor.

7. The method of claim 6, wherein when the data bit associated with the turbidity sensor in the communication data packet is set to a first value, the control unit determines that there is no need to measure a data of the turbidity sensor, and controls the switch circuit to be turned off, and when the data bit associated with the turbidity sensor in the communication data packet is set to a second value, the control unit determines that there is a need to measure the data of the turbidity sensor, and controls the switch circuit to be turned on.

8. The method of claim 1, further comprising injecting a calibration liquid into the smart cleaning device after the providing step and before the controlling step.

9. The method of claim 1, wherein the smart cleaning device is a washing machine or a dishwasher.

10. A sensor module for a smart cleaning device, comprising:
a plurality of sensors including at least one turbidity sensor;
a control unit;
a switch circuit;
a calibration circuit and
a measurement circuit, the control unit controls the switch circuit to be turned on to supply power to the turbidity sensor in response to a calibration command to the turbidity sensor from a main controller of the smart cleaning device, adjusts an input of the turbidity sensor via the calibration circuit, obtains an output of the turbidity sensor via the measurement circuit, and adjusts the input of the turbidity sensor based on the output of the turbidity sensor until the output of the turbidity sensor meets a preset range, and sends calibration completion information to the main controller.

11. The sensor module of claim 10, wherein the main controller is communicatively connected to the sensor module via a data bus.

12. A smart cleaning device, comprising:
a main controller; and
a sensor module including a plurality of sensors having at least one turbidity sensor, a control unit, a switch circuit, a calibration circuit, and a measurement circuit, the control unit controls the switch circuit to be turned on to supply power to the turbidity sensor in response to a calibration command to the turbidity sensor from the main controller, adjusts an input of the turbidity sensor via the calibration circuit, obtains an output of the turbidity sensor via the measurement circuit, and adjusts the input of the turbidity sensor based on the output of the turbidity sensor until the output of the turbidity sensor meets a preset range, and sends calibration completion information to the main controller, the sensor module is communicatively connected to the main controller.

13. The smart cleaning device of claim 12, wherein the smart cleaning device is a washing machine.

14. The smart cleaning device of claim 12, wherein the smart cleaning device is a dishwasher.
